(19) United States
(12) Patent Application Publication
(10) Pub. No.: US 2024/0019991 A1
(43) Pub. Date: Jan. 18, 2024

(54) METHOD, APPARATUS, ELECTRONIC DEVICE, STORAGE MEDIUM AND PROGRAM PRODUCT FOR CONTENT SHARING

(71) Applicant: Beijing Zitiao Network Technology Co., Ltd., Beijing (CN)

(72) Inventor: Lan DAI, Beijing (CN)

(21) Appl. No.: 18/470,667

(22) Filed: Sep. 20, 2023

(30) Foreign Application Priority Data
Sep. 27, 2022 (CN) 202211186821.X

(51) Int. Cl. G06F 3/0484; G06F 3/0482; G06F 9/451

(52) U.S. Cl. CPC G06F 3/0484; G06F 3/0482; G06F 9/451; G06F 2203/04803

(57) ABSTRACT

The present disclosure provides a method, an apparatus, an electronic device, a storage medium, and a program product for content sharing. The method includes: in response to acquiring a preset content input by a first user account in a service interface, displaying a first window in the service interface, the first window including at least one content to be shared; and in response to a selection operation on at least one target shared content in the at least one content to be shared, sharing the at least one target shared content to at least one second user account corresponding to the service interface. The service interface includes an interface of an instant messaging session interface, a live streaming interface, or a video conference interface, and a category of the content to be shared includes at least one of a group contact card and a cloud document.

### CROSS-REFERENCE TO RELATED APPLICATIONS

This application claims priority to Chinese Patent Application No. 202211186821.X, filed on Sep. 27, 2022, and titled Method, Apparatus, Electronic Device, Storage Medium and Program Product for Content Sharing”, the disclosure of which is incorporated herein by reference in its entirety.

### FIELD

Embodiments of the present disclosure generally relate to the field of computers, and more specifically, to a method, an apparatus, an electronic device, a storage medium and a program product for content sharing.

### BACKGROUND

Nowadays, in a multi-person interaction scene, if desiring to share a content, such as a personal contact card, a group contact card, a cloud document or the like, in a private or group chat, a user has to exit a service interface of the private or group chat, find the corresponding personal contact card, the corresponding group contact card or the corresponding cloud document in a corresponding list or through a search bar, then share the same with the private or group chat, and thereafter return to the service interface of the private or group chat.

Such a sharing method has a relatively long operation path, and accordingly, brings much inconvenience for a user in use and results in a relatively low efficiency.

### SUMMARY

In view of the above, the objective of the present disclosure is to provide a method, an apparatus, an electronic device, a storage medium and a program product for content sharing.

To this end, in a first aspect of the present disclosure, there is provided a method of content sharing, including: in response to acquiring a preset content input by a first user account in a service interface, displaying a first window in the service interface, the first window including at least one content to be shared; and in response to a selection operation on at least one target shared content in the at least one content to be shared, sharing the at least one target shared content to at least one second user account corresponding to the service interface, wherein the service interface includes an interface of an instant message session interface, a live streaming interface, or a video conference interface, and a category of the at least one content to be shared includes at least one of a group contact card and a cloud document.

In a second aspect of the present disclosure, there is provided an apparatus for content sharing, including: a display module configured to: in response to acquiring a preset content input by a first user account in a service interface, display a first window in the service interface, the first window including at least one content to be shared; and a sharing module configured to: in response to a selection operation on at least one target shared content in the at least one content to be shared, sharing the at least one target shared content with at least one second user account corresponding to the service interface, wherein the service interface include an interface of an instant message session interface, a live streaming interface, or a video conference interface, and a category of the content to be shared include at least one of a group contact card and a cloud document.

In a third aspect of the present disclosure, there is provided a computer device, comprising: one or more processors; a memory, coupled to the one or more processor, wherein one or more programs are stored in the memory, and the one or more programs, when executed by the one or more processors, cause the apparatus to implement the method of the first aspect.

In a fourth aspect of the present disclosure, there is provided a non-transient computer readable storage medium having program instructions stored thereon, the program instructions, when executed by a processor, cause the processor to implement the method of the first aspect.

In a fifth aspect of the present disclosure, there is provided a computer program product, including program instructions, the program instructions, when executed by a processor, cause the processor to implement the method of the first aspect.

As can be seen above, in a multi-person interaction scene, the method, apparatus, electronic device, storage medium and program product for content sharing provided by the present disclosure can directly display a first window displaying a content to be shared based on an input preset content, enabling a user to directly select a desired content to be shared in the first window. Therefore, a content sharing path for a user in the multi-person interaction scene is shortened, the efficiency of user communication and interaction is increased, and the user experiences are improved.

### BRIEF DESCRIPTION OF THE DRAWINGS

In order to make clear the technical solution of the present disclosure or the related technology, brief introduction will be provided hereinafter on the drawings necessary for description of the embodiments or the related technology. Apparently, the drawings described below only relate to embodiments of the present disclosure, on the basis of which the ordinary skilled in the art could obtain other drawings, without doing creative work.

FIG. 1 illustrates a schematic diagram of an example system provided according to embodiments of the present disclosure.

FIG. 2A illustrates a schematic diagram of an example page according to embodiments of the present disclosure.

FIG. 2B illustrates a schematic diagram of an example page according to embodiments of the present disclosure.

FIG. 2C illustrates a schematic diagram of an example page according to embodiments of the present disclosure.

FIG. 2D illustrates a schematic diagram of an example page according to embodiments of the present disclosure.

FIG. 2E illustrates a schematic diagram of an example page according to embodiments of the present disclosure.

FIG. 2F illustrates a schematic diagram of an example page according to embodiments of the present disclosure.

FIG. 2G illustrates a schematic diagram of an example page according to embodiments of the present disclosure.

FIG. 2H illustrates a schematic diagram of an example page according to embodiments of the present disclosure.

FIG. 2I illustrates a schematic diagram of an example page according to embodiments of the present disclosure.

FIG. 2J illustrates a schematic diagram of an example page according to embodiments of the present disclosure.

FIG. 2K illustrates a schematic diagram of an example page according to embodiments of the present disclosure.

FIG. 3A illustrates a schematic diagram of an example page according to embodiments of the present disclosure.

FIG. 3B illustrates a schematic diagram of an example page according to embodiments of the present disclosure.

FIG. 3C illustrates a schematic diagram of an example page according to embodiments of the present disclosure.

FIG. 3D illustrates a schematic diagram of an example page according to embodiments of the present disclosure.

FIG. 3E illustrates a schematic diagram of an example page according to embodiments of the present disclosure.

FIG. 3F illustrates a schematic diagram of an example page according to embodiments of the present disclosure.

FIG. 3G illustrates a schematic diagram of an example page according to embodiments of the present disclosure.

FIG. 3H illustrates a schematic diagram of an example page according to embodiments of the present disclosure.

FIG. 4 illustrates a schematic flowchart of an example method provided according to embodiments of the present disclosure.

FIG. 5 illustrates a schematic diagram of an example apparatus provided according to embodiments of the present disclosure.

FIG. 6 illustrates a schematic diagram of a hardware structure of an example computer device provided according to embodiments of the present disclosure.

### DETAILED DESCRIPTION OF EMBODIMENTS

The objective, technical solution and advantages of the present disclosure will become more apparent, through the following detailed description of the present disclosure in conjunction with embodiments and with reference to the accompanying drawings.

It is worth noting that, unless defined otherwise, technological or scientific terms used in embodiments of the present disclosure should have common meanings that could be understood by the ordinary skilled in the art. The words “first,” “second” and the like used herein are only employed to differentiate different components, rather than indicating any sequence, number or importance. The word “include,” “comprise” or the like used here refer to that an element or object preceding it encompasses element(s), object(s) or equivalence listed following it, without excluding other element(s) or object(s). The word “couple,” “connect” or the like is not restricted to a physical or mechanical connection, but may also include an electrical connection, irrespectively of being direct or indirect. “Upper,” “lower,” “left,” “right” or the like is only used to indicate a relative positional relationship which may be changed correspondingly if an absolute position of an object described is changed.

As aforementioned in the technical background, in a multi-person interaction scene, such as an instant chat, a live streaming, a video conference or the like, if desiring to share a content, such as a personal contact card, a group contact card, a cloud document or the like, in a private or group chat, a user has to exit the service interface of the private or group chat, find the corresponding personal contact card, group contact card or cloud document in a corresponding list or through the search bar, then share the same with the private or group chat, and thereafter return to the service interface of the private or group chat.

Sharing a cloud document is taken as an example. When desiring to share a cloud document in a chat interface, a user has to exit the chat interface (e.g., the chat interface is closed, minimized, or hidden at an underlying layer of another interface), then find the cloud document to be shared by entering into the cloud document list or searching in a search window, enter into the group list or obtain a target group through the search window after copying a link which is linked to the cloud document, and share the cloud document to the target group after clicking a “Send” button.

Alternatively, the user may enter into the cloud document list or find the cloud document to be shared through the search window, click “view the specific content of the cloud document” to enter into the cloud document interface, then enter into the group list or find the target group through the search window after clicking a “Share” button in the cloud document interface or copying the link, and share the cloud document to the target group by clicking the “Send” button.

Alternatively, the user may directly search for the document to be shared in a browser, click “view the specific content of the cloud document” to enter into the cloud document interface, then enter into the group list or find the target group through the search window after clicking a “Share” button in the cloud document interface or copying the link, and share the cloud document to the target group by clicking the “Send” button.

A relatively long operation path is involved in the cloud document sharing method described above, resulting in a low communication efficiency during user interaction and much inconvenience for a user in use. In view of the above, embodiments of the present disclosure provide a content sharing method, including: in response to acquiring a preset sign input by a first user account in a service interface, displaying a first window in the service interface, the first window including at least one content to be shared; and in response to a selection operation on at least one target shared content in the at least one content to be shared, sharing the at least one target shared content to a second user account corresponding to the service interface, such that the at least one target shared content can be directly acquired in the service interface and shared to the second user account. Such a method can accomplish content sharing only with fewer operations, and has a relatively short sharing operation path, increasing the efficiency of user communication and interaction, and improving user experiences.

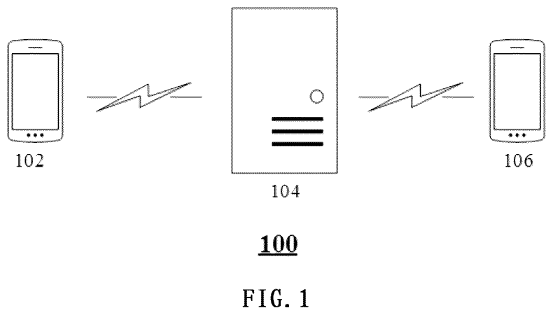

FIG. 1 illustrates a schematic diagram of an example system 100 provided according to embodiments of the present disclosure.

As shown in FIG. 1, the system 100 may include a first terminal 102, a server 104 and a second terminal 106. The first terminal 102 and the second terminal 106 are only used to differentiate different electronic devices, rather than suggesting the number of electronic devices in an application scenario. In practice, there may be multiple electronic devices. The first electronic device 110 or second electronic device 120 may include, but not limited to, a desktop computer, a mobile phone, a mobile computer, a tablet, a media player, a smart wearable device, a person digital assistant (PDA) or other electronic device that may implement the above-mentioned function.

In some embodiments, the system 100 may be applied to a multi-person interaction scene which may include, for example, an instant messaging scene, a live streaming scene, a video conference scene or the like. An instant messaging session scene is taken as an example. The server 104 is used to provide an instant messaging service. The first terminal 102/the second terminal 106 is a terminal corresponding to a user who chats and communicates in the instant messaging scene, and may have a client communicating with the second terminal 106/the second terminal 102 installed thereon, through which the user may enter into the multi-person interaction scene, such as a multi-person chat scene, a multi-person live-streaming scene or the like. In some embodiments, the first terminal 102 may be a terminal of a first user that needs to implement content sharing in the instant messaging scene, and the first terminal 102 is set with a first user account. The second terminal 106 may be a terminal corresponding to a second user receiving the shared content, and the second terminal 106 is set with a second user account.

In some embodiments, when the system 100 is applied to a private chat scene, the first terminal 102 and the second terminal 102 may be provided in singular, respectively. In some embodiments, when the system 100 is applied to a multi-person chat scene, the second terminal 106 may be provided in plural.

The server 104 may be a single server or multiple servers. In the case of multiple servers, those servers may be of distributed architecture, and may be formed in a server cluster.

The first terminal 102 and the second terminal 106 may be any terminal devices, for example, which may be mobile terminals (e.g. mobile phones or Pads), or may be fixed terminals (e.g. personal computers (PCs) or laptops). The first terminal 102 and the second terminal 106 may run an application program, and a corresponding service, such as a chat service, may be provided by the application program to a user.

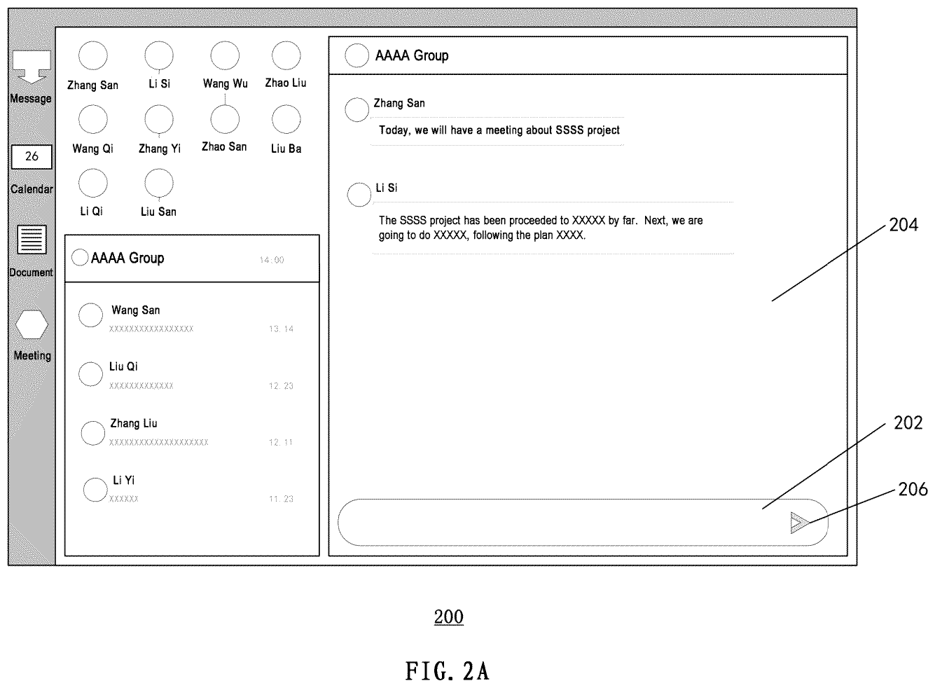

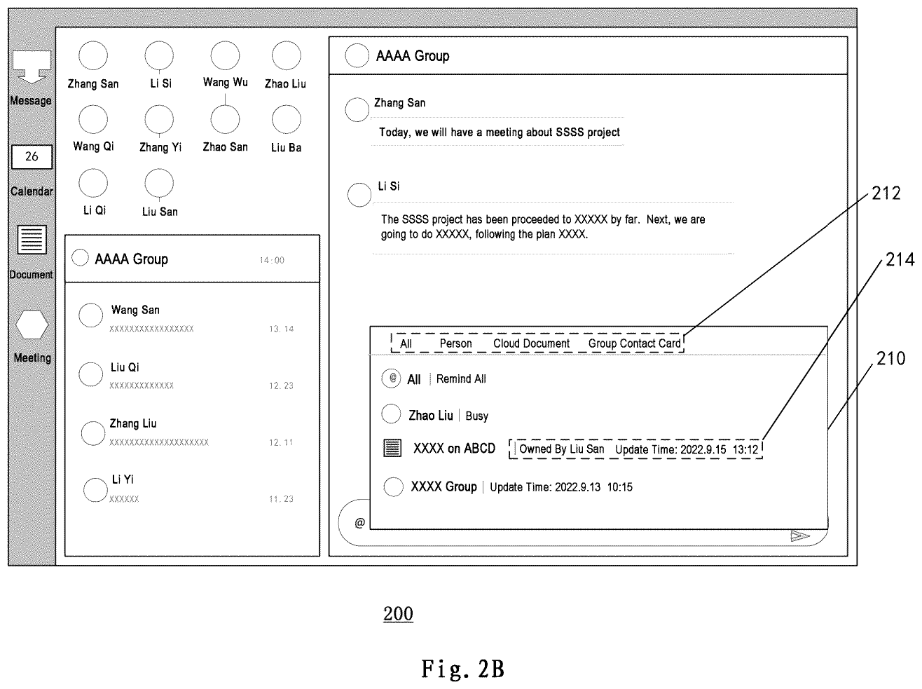

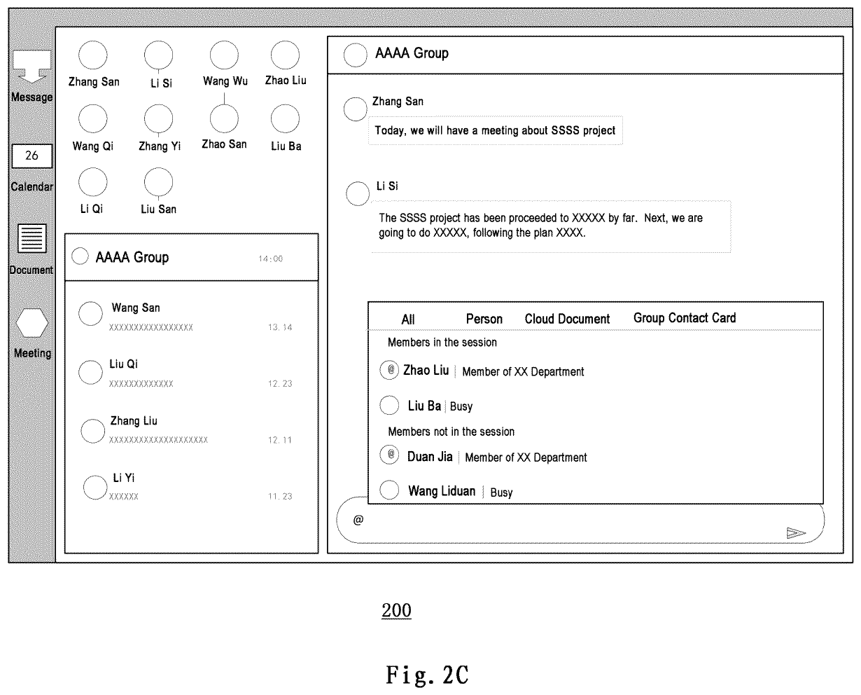

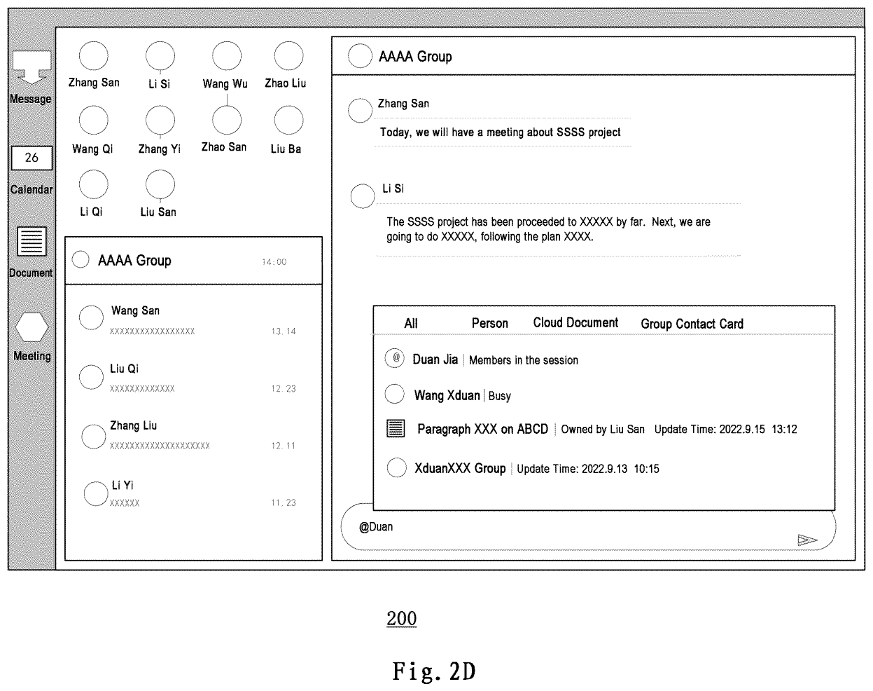

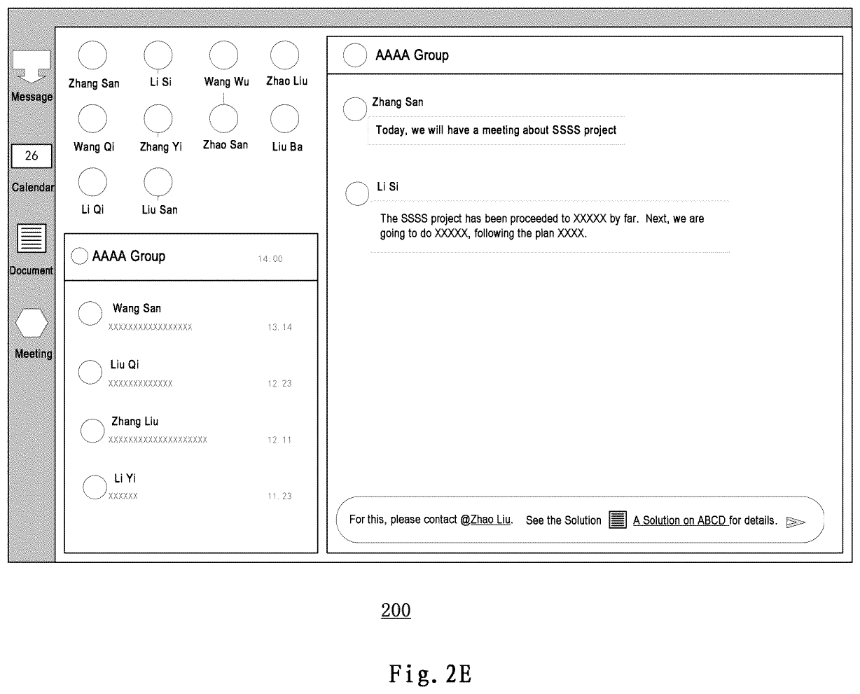

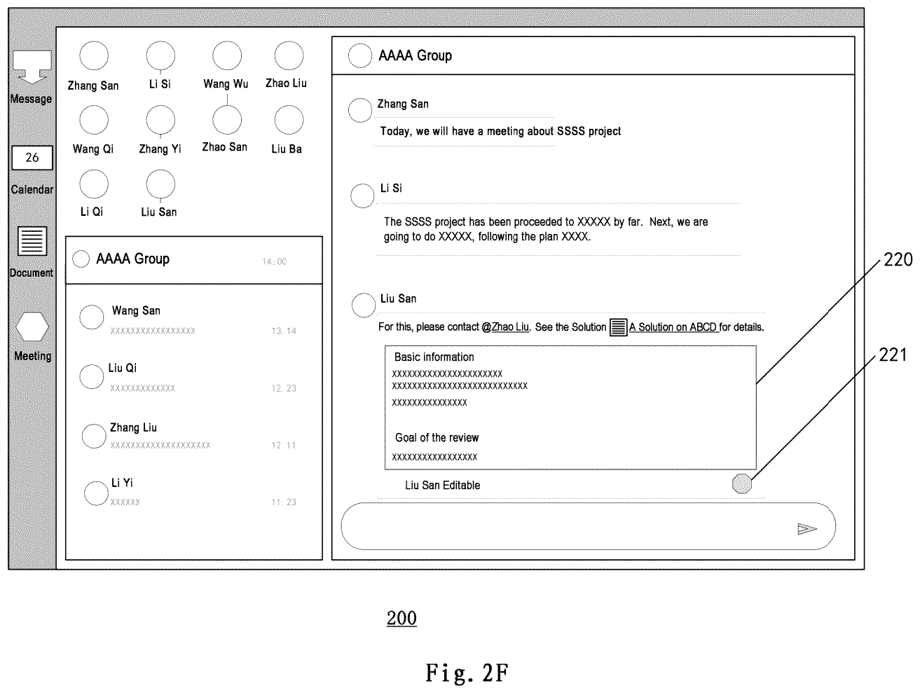

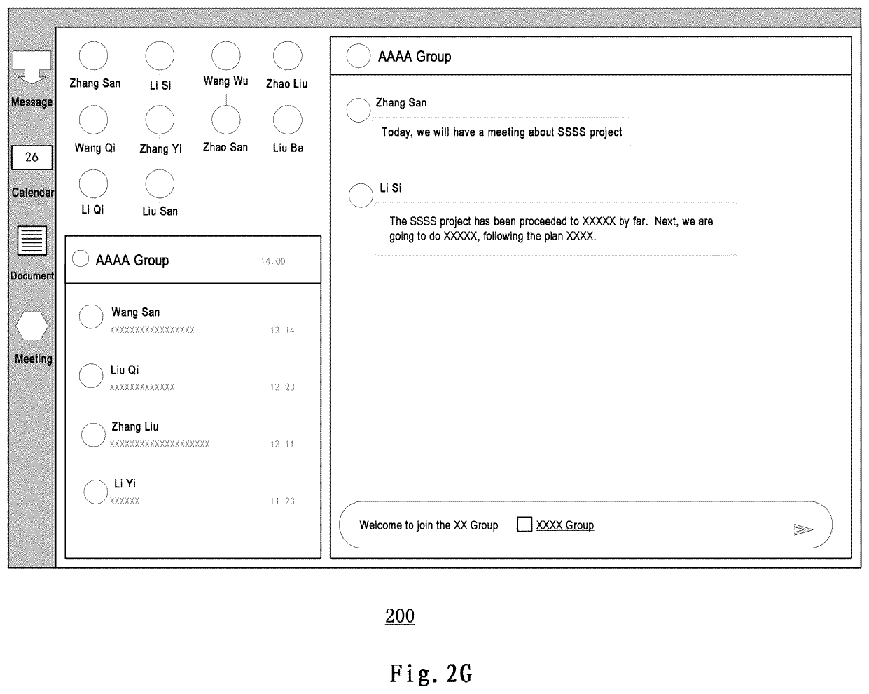

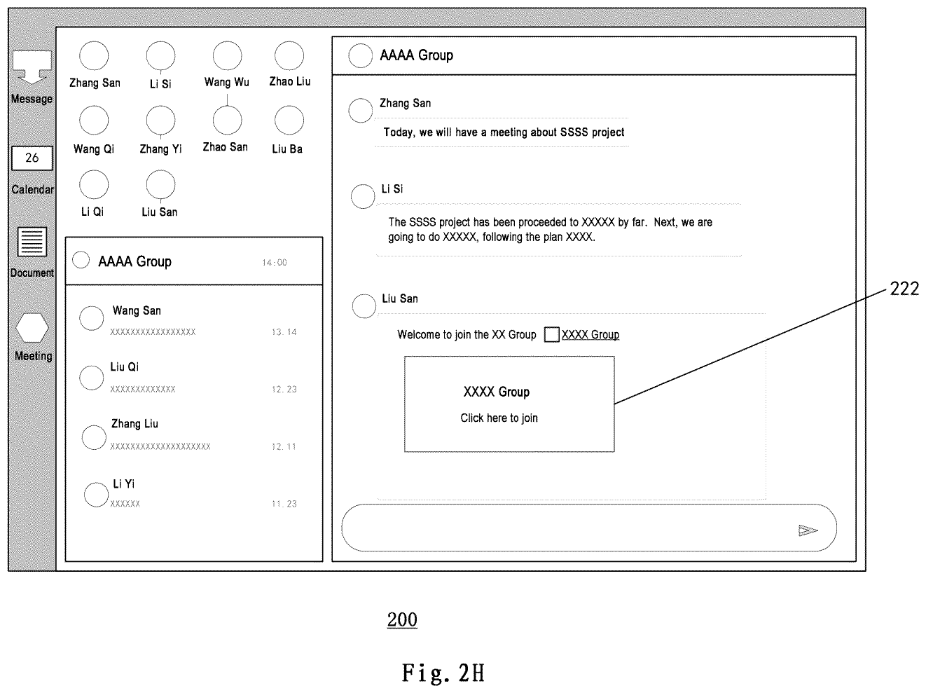

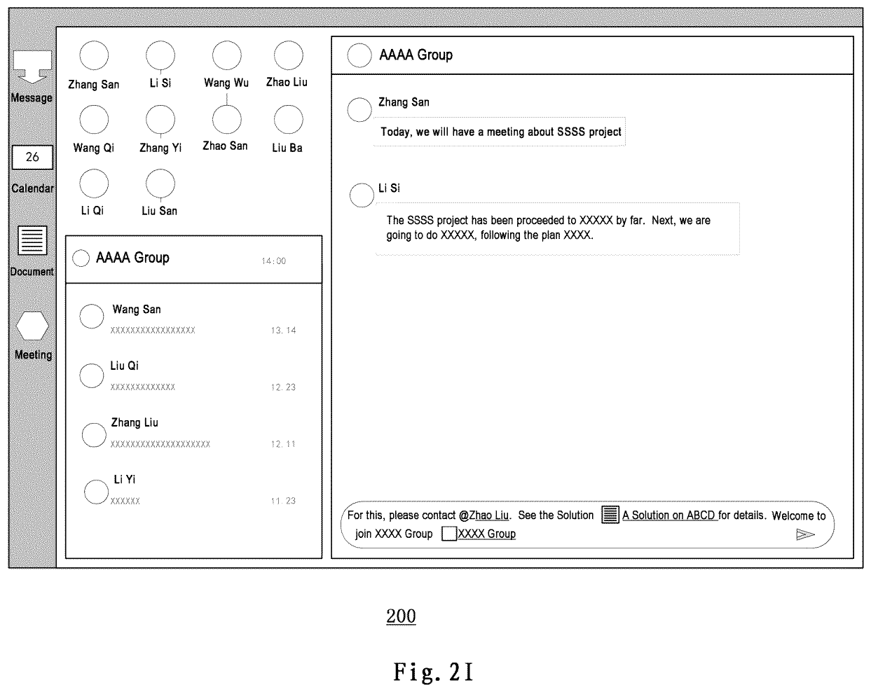

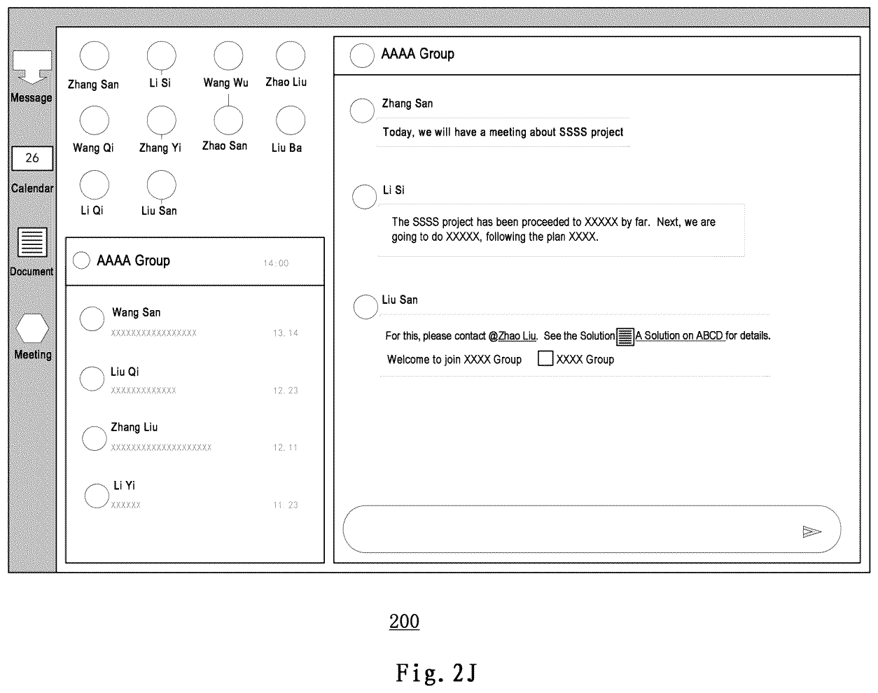

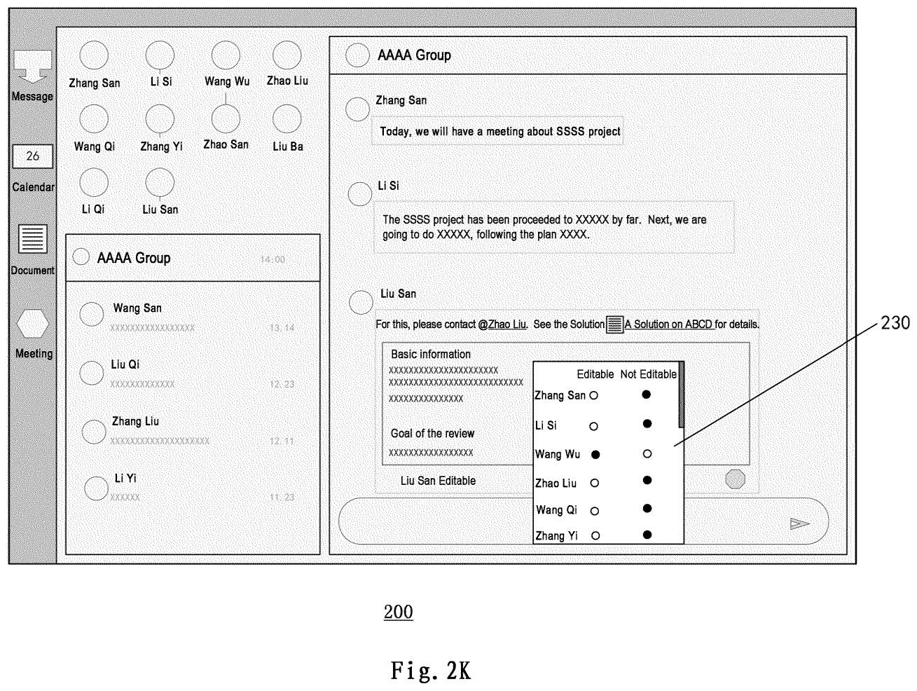

FIG. 2A illustrates a schematic diagram of an example page 200 according to embodiments of the present disclosure.

As shown therein, in a multi-person interaction scene, for example, an instant messaging session scene, after a user sends a message in a group, the user having sent the message and other users in the group may reply to the message.

When the first user shares, on the first terminal 102, a content to a group through a first user account, the first user may input a preset content on a service interface 200 of the first terminal 102 through the first user account. In some embodiments, the preset content may be any predetermined character(s), for example, which may include @ #, / or the like; or the preset content may be any predetermined alphabet(s), number(s) or the like, which is not limited in the present disclosure. @ is taken herein as an example to describe in detail the technical solution of the present disclosure.

In some embodiments, the service interface 200 may include a multi-person interaction interface from an instant messaging session interface, a live streaming interface, a video conference interface and the like, and the service interface 200 may include an input field 202 and a display field 204. The first user may implement pre-input of a message in the input field 202 on the first terminal 102, and the message in the input field 202 of the first terminal 102 may be seen only by the first user holding the first user account, but is invisible to a second user holding the second user account.

After inputting the message in the input field 202, the first user may send the message pre-input in the input field 202 to the display field 204 by clicking a send component 206 or through a preset shortcut, and the second user holding the second user account may instantly read the message on the service interface of the second terminal 106, completing an instant communication of the message.

In some embodiments, as shown in FIG. 2B, the first user inputs a preset content on the service interface 200 of the first terminal 102 through the first user account, i.e., the first user inputs a preset content, for example, a preset sign @, in the input field 202 of the service interface 200. Then, the first terminal 102 acquires the preset content input by the first user account on the service interface 200, and displays, on the service interface 200, a first window 210 which includes at least one content to be shared. In some embodiments, a category of the at least one content to be shared includes at least one of a group contact card and a cloud document. In addition, the category of the at least one content to be shared may include a personal contact card, an applet and the like. This is not limited in the present disclosure.

In some embodiments, if a category of the at least one content to be shared includes a personal contact card, the at least one content to be shared and displayed in the first window 210 may include a name and an avatar of the person, to enable the first user to accurately find the personal contact card of the person to be shared. In some embodiments, if a category of the at least one content to be shared includes a group contact card, the at least one content to be shared and displayed in the first window 210 may include a group name and an avatar of the group, to enable the first user to accurately find the group contact card of the group to be shared. In some embodiments, if a category of the at least one content to be shared includes a cloud document, the at least one content to be shared and displayed in the first window 210 may include a document name of the cloud document, to enable the first user to accurately find the cloud document to be shared.

As shown in FIG. 2B, when the first window 210 includes multiple contents to be shared, the contents to be shared are displayed in the first window 210 in a form of a list. Alternatively, the first window 210 may partially cover the service interface 200, for example, only partially cover the display field 204, and therefore, when performing the sharing operation, the first user is free from influence to view the message information displayed in the display field 204. Alternatively, the first window 210 may fully cover the service interface 200 or the display field 204, which is not limited in the present disclosure.

Alternatively, the first window 210 may display 5-15 contents to be shared. When the number of contents to be shared is great, only a few (e.g. 4-7) of contents to be shared are displayed in the first window 210, and the displayed contents in a viewport of the first window 210 may be changed by dragging a slider arranged at an edge of the first window 210, such that other contents to be shared in the first window 210 may be viewed.

In some embodiments, as shown in FIG. 2B, the first window 210 includes at least one category label 212 that is used to differentiate the categories of the contents to be shared, and the contents to be shared in the same category are displayed on the same TAB page while contents to be shared in different categories are displayed in different TAB pages, such that the user may quickly find a target shared content to be shared in the contents to be shared. In some embodiments, the category label may include a person, a cloud document, a group contact card, an applet or the like, respectively corresponding to category information, such as a personal contact card, a group contact card, a cloud document, an applet or the like.

When the first window 210 includes category labels, in response to a trigger operation on a target label in at least one category label, the at least one content to be shared matching the target label is displayed in the first window 210. That is, in some embodiments, since the contents to be shared in different categories are displayed in pages of different category labels, upon receiving a trigger operation (e.g. clicking) on a certain category label, the first terminal 101 displays the at least one content to be shared matching the category label in the first window 210. For example, supposing that the first user clicks the category label “person” (i.e., the target label for the first user is a person), a recommended list of personal contact cards matching the category label “person” is displayed in the first window 210.

In some embodiments, when the number of categories of the contents to be shared is at least two, the category labels may include at least two first sublabels and a second sublabel, in which each of the first sublabels matches with a category of the respective contents to be shared, and the second sublabel matches with all the contents to be shared.

In the embodiment, when the categories of the contents to be shared include at least two of the personal contact card, the group contact card and the cloud document, the number of the first sublabels is identical to the number of categories to be shared, in which each of the first sublabels matches with a category in the personal contact card, the group contact card and the cloud document, and the second sublabel matches with all contents to be shared of all the categories including the personal contact card, the group contact card and the cloud document. Supposing that the categories of the contents to be shared include a personal contact card, a group contact card and a cloud document, the number of the first sublabels is three, which are specifically a person, a group contact card and a cloud document. The TAB pages corresponding to the three first sublabels are respectively used to display contents to be shared of the categories including the personal contact card, the group contact card and the cloud document. The TAB page corresponding to the second sublabel is used to display the contents to be shared of the mixed three categories including the personal contact card, the group contact card and the cloud document, and the label name for the second sublabel may be “all.” In this way, when selecting a target shared content, the first user can enter into an appropriate TAB page according to the need to make a selection, so as to improve content sharing efficiency of the user.

In some embodiments, as shown in FIG. 2B, label information 214 corresponding to the at least one content to be shared is displayed in the first window 210, and the label information 214 is used to indicate an attribute of the content to be shared.

In some embodiments, when a content to be shared is a personal contact card, the label information 214 may include a personal status and/or a personal label of the person, where the personal status and/or the personal label may be set by the person through his own user account, such that, when the first user searches the personal contact card of the person to be shared, the first user may further determine the personal contact card of the person to be shared based on the personal status and/or the personal label even though personal information including the same name and even the same avatar is presented in the first window 210.

When a content to be shared is a group contact card, the label information 214 may include update time of a group message in the group, for example, “the message was last updated on the moment of: X (year) X (month) X (day) X (time).” In this way, even though repeated group names, highly similar group names, long group names having similar front portions or the like are displayed in the first window 210, the first user may also find the group contact card to be shared easily therefrom.

When a content to be shared is a cloud document, the label information 214 may include a document owner and/or a document update time of the document. In this way, even though a document with the same name or a similar name is displayed in the first window 210, the first user may easily find the cloud document to be shared therefrom.

In some embodiments, the contents to be shared in the first window 210 may be sorted according to a predetermined sorting rule.

For example, in a TAB page corresponding to a personal contact card, based on familiarities, multiple personal contact cards each having a familiarity satisfying a preset requirement may be displayed in the first window 210. In some embodiments, a familiarity may be computed based on information, such as a number of chats, a chat frequency, a chat duration and the like, between the current first user account and another user account, and therefore, multiple personal contact cards having the top highest familiarities are selected to be displayed in the first window 210, which is not limited in the present disclosure.

In a TAB page corresponding to a group contact card, based on familiarities, multiple group contact cards each having a familiarity satisfying a preset requirement may be displayed in the first window 210. In some embodiments, a familiarity may be computed based on information, such as a browsing time, a browsing frequency, an interaction time, an interaction frequency and the like, of the first user account in the group, and therefore, multiple group contact cards having the top highest familiarities or the most interactions are selected to be displayed in the first window 210, which is not limited in the present disclosure.

In a TAB page corresponding to a cloud document, based on familiarities, multiple personal contact cards each having a familiarity satisfying a preset requirement may be displayed in the first window 210. In some embodiments, a familiarity or a browsing status may be computed based on information, such as a browsing time, a browsing frequency, a number of editing, a duration of editing and the like, of the first user account operating on the cloud documents, and therefore, multiple cloud documents having the top highest familiarities or the longest browsing times are selected to be displayed in the first window 210, which is not limited in the present disclosure.

In a TAB page corresponding to “all,” the contents of the respective categories to be shared may be displayed according to a preset order (for example, in a sequential order of personal contact cards, group contact cards and cloud documents). In some embodiments, in the display of each category, sorting is performed according to a sorting rule of the corresponding category, such that the contents to be shared may be display in the first window 210.

In some embodiments, a content to be shared are related to the service interface 200, and/or a content to be shared are not related to the service interface 200. In some embodiments, a content to be shared being related to the service interface 200 may include: a personal contact card to be shared is a group member in a group corresponding to the service interface 200, or a cloud document to be shared has been analyzed in a group corresponding to the service interface 200. Correspondingly, a content to be shared being not related to the service interface may include: a personal contact card to be shared is not a group member in a group corresponding to the service interface 200, or a cloud document to be shared has not been analyzed in a group corresponding to the service interface 200, which is not limited in the present disclosure.

In this way, when contents to be shared are displayed in the first window 210, only a content to be shared which is related to the service interface may be displayed, or only a content to be shared which is not related to the service interface may be displayed, or a content to be shared which is related to the service interface and a content to be shared which is not related to the service interface may be displayed in the first window 210, respectively, which is not limited in the present disclosure.

In the embodiment, as shown in FIG. 2C, a content to be shared which is displayed in the first window 210 may be related to the service interface 200, or may not be related to the service interface 200 (i.e., a personal contact card shared by the first user may be a contact card of a member in the group (i.e., a personal contact card of a member participating in the session), or may be a contact card of a member in an organization, such as a further group or the like (i.e., a personal contact card of a member not participating in the session)), and the personal contact card of a member participating in the session and the personal contact card of a member not participating in the session are displayed hierarchically, to provide the user with convenience in recommendation.

In some other embodiments, an input content subsequent to the preset content in the input field 202 may be acquired, and the at least one content to be shared in the first window 210 may be determined based on the input content subsequent to the preset content. In some embodiments, after the preset symbol @ is input, based on a subsequently input content (i.e., a right operator of the preset symbol @), a content to be shared that is related to the right operator may be determined and displayed in the first window 210.

As shown in FIG. 2D, after the preset symbol @ is input in the input field 202, the first window 210 is displayed. Thereafter, inputting continues in the input field 202, and at this time, the right operator “Duan” of the preset symbol @ is acquired. Searching is performed based on the right operator “Duan.” Contents to be shared which are related to the right operator “Duan” are selected, for example, personal contact cards including “Duan” in the names, group contact cards including “Duan” in the group names or group chat messages, and cloud documents including “Duan” in the document names or document contents. The selected contents related to the right operator are displayed in the first window 210 after sorting is performed according to familiarities and/or degree of match.

After the contents to be shared are displayed in the first window 210, the first user may perform a selection operation on at least one target shared content in the at least one content to be shared, to share the at least one target shared content to a second user account corresponding to the service interface.

In the embodiment, the first user may perform a selection operation on the at least one target shared content in the at least one content to be shared via the first terminal 102, and the first terminal 102 may display identification information of the at least one target shared content in the input field 202 to generate a content to be input in the input field 202. In some embodiments, the at least one target shared content that is displayed in the input field may include: at least one of a group name corresponding to a group contact card and a document name corresponding to a cloud document; or message information and at least one of a person's name corresponding to a personal contact card, a group name corresponding to a group contact card and a document name corresponding to a cloud document.

As shown in FIG. 2E, identification information of a personal contact card may include a person's name “Zhao Liu” of the personal contact card, a document name “A solution On ABCD” corresponding to a cloud document, and a cloud document icon. As shown in FIG. 2G, identification information of a personal contact card may include a group name “XXXX group” corresponding to a group contact card and an icon of the group contact card. As shown in FIGS. 2E and 2G, the message information may be words, alphabets or the like.

After inputting the content to be input in the input field 202, the first user may perform a send operation on the input field 202 via the first terminal 102. For example, the first user may send the displayed content including the at least one target shared content in the input field by clicking an information sending component on the service interface 200 or through a shortcut. The at least one target shared content sent may be immediately displayed in the display field 204 of the service interface. In this way, the second user account may acquire an access to the at least one target shared content based on the message.

In the embodiment as mentioned above, as shown in FIG. 2F, when a target shared content includes a person's name corresponding to a personal contact card, the person's name and an access to the person's name are displayed in the display field 204, and the second user account may apply for adding the person corresponding to the personal contact card as a contact via the access, or awaken the service interface of the person corresponding to the personal contact card via the access.

Alternatively, when a target shared content includes a person's name corresponding to a personal contact card and the message information, the person's name, the message information, and an access corresponding to the person's name are displayed in the display field 204, the second user account may view the message information, or may apply for adding a person corresponding to the personal contact card as a contact via the access, or awaken the service interface of the person corresponding to the personal contact card via the access.

As shown in FIG. 2F, when a target shared content includes a document name, or includes a document name and a person's name corresponding to a personal contact card, a card component for a cloud document 220 corresponding to the cloud document is displayed in the display field 204. In some embodiments, the card component for the cloud document 220 includes an access corresponding to the cloud document, and the second user may access the cloud document using the access through the second user account. The card component for the cloud document 220 may further include partial contents of the cloud document, to enable the user to have a general knowledge about the cloud document and thus determine whether the document is the desired one.

Alternatively, when a target shared content only includes a document name and message information, the message information and a card component for a cloud document 220 corresponding to the cloud document are displayed in the display field 204. The second user may view the message information, and access the cloud document using an access in the card component for the cloud document 220 through the second user account.

Alternatively, when a target shared content includes a document name, message information, and a person's name corresponding to a personal contact card, the person's name, the message information, an access corresponding to the person's name, and a card component for a cloud document 220 corresponding to the cloud document are displayed in the display field 204.

Alternatively, a card component for a cloud document 220 corresponding to the cloud document may further display a permission to the cloud document, for example, edit permissions, read permissions or the like for a certain person. Alternatively, the card component for the cloud document 220 may only display a document name and an access corresponding to the document name, which is not limited in the present disclosure.

As shown in FIG. 2H, when a target shared content includes a group name corresponding to a group contact card only, or includes both a group name and a person's name corresponding to a personal contact card, a card component for the group contact card 222 corresponding to the group contact card is displayed in the display field 204. In some embodiments, the card component for the group contact card 222 may include an access corresponding to the group contact card, and the second user may apply for joining the group through the second user account through the access. The card component for the group contact card 222 may further include brief information of the group contact card, to provide convenience to a user in determining whether the group is desired. Alternatively, only a group name and an access corresponding to the group name may be displayed, which is not limited in the present disclosure.

Alternatively, when a target shared content only includes a group name corresponding to a group contact card and message information, the message information and a card component for the group contact card 222 corresponding to the group contact card are displayed in the display field 204. The second user may view the message information, and apply for joining the group through the second user account through the access.

Alternatively, when a target shared content includes a group name corresponding to a group contact card, the message information, and a person's name corresponding to a person contact card simultaneously, the message information, the person's name, an access corresponding to the person's name, and a card component for the group contact card 222 corresponding to the group contact card are displayed in the display field 204.

As shown in FIGS. 21 and 2J, when a target shared content simultaneously includes a group name corresponding to a group contact card and a document name, or simultaneously includes a group name, a document name corresponding to a group contact card and a person's name, the group name, the document name, and respective accesses corresponding to the group name and the document name are displayed in the display field, without a card component for the cloud document 220 or a card component for the group contact card 222 being displayed.

Alternatively, when a target shared content simultaneously includes a group name corresponding to a group contact card, a document name, and message information, the message information, the group name, the document name and respective accesses corresponding to the group name and the document name are displayed in the display field, without a card component for the cloud document 220 or a card component for the group contact card 222 being displayed.

Alternatively, when a target shared content simultaneously includes a group name corresponding to a group contact card, a document name, a person's name and the message information, the message information, the group name, the document name and respective accesses corresponding to the group name and the document name are displayed in the display field, without a card component for the cloud document 220 or a card component for the group contact card 222 being displayed.

In some embodiments, when the at least one target shared content is displayed in the display field of the service interface, it further includes: setting a first permission of the at least one target shared content to be a default value, such that the second user account may perform a first operation on the at least one target shared content.

In some embodiments, when the at least one target shared content includes a cloud document, the first permission may be a read permission. When a first user shares a cloud document to a second user, the second user may typically read the cloud document by default, and the read permission may thus be set to “readable.” As such, the second user may perform a read operation on the cloud document through the second user account.

In some other embodiments, when the at least one target shared content is displayed in the display field of the service interface, it further includes: in response to a trigger operation on a first target widget component corresponding to the at least one target shared content in the display field, displaying a second window in the service interface, in which the second window is used for setting a second permission for the at least one target shared content; in response to a permission setting operation, performed by a user, on the second permission of the at least one target shared content in the second window, setting the second permission of the at least one target shared content to a second permission value, such that the second user account may perform a second operation on the at least one target shared content. In some embodiments, a number of the second user account is one or more than one, and in response to the second user accounts being more than one, multiple second permissions set for the multiple second user accounts may be the same or different.

As shown in FIG. 2F, when displaying the at least one target shared content, the display field 204 may also display a first target widget component 221 for setting a second permission. In some embodiments, when the at least one target shared content includes a cloud document, the second permission may be an edit permission; or, when the at least one target shared content includes a group contact card, the second permission may be a group joining permission or the like.

As shown in FIG. 2K, when the first user triggers the first target widget component 221, a second window 230 is displayed in the service interface 200, i.e., an edit permission for each second user account to edit the cloud document may be set in the second window 230. In some embodiments, when the number of the second user accounts is more than one, edit permissions may be set separately based on each second user account, and the respective edit permissions of the second user accounts may be the same or may be different, which is not limited in the present disclosure.

Alternatively, in the above-mentioned embodiments, when the at least one target shared content that is displayed in the input field 202 or in the display field 204 of the service interface 200 includes a group contact card or a cloud document, the preset sign @ may not be displayed for the aesthetic consideration, which is not limited in the present disclosure.

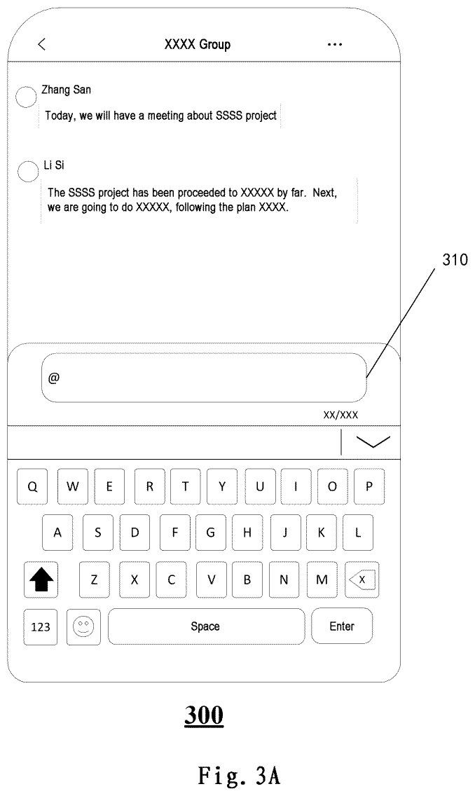

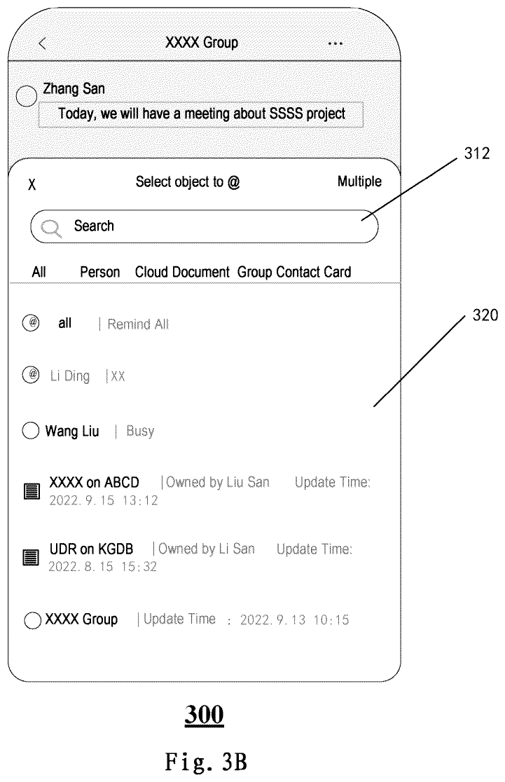

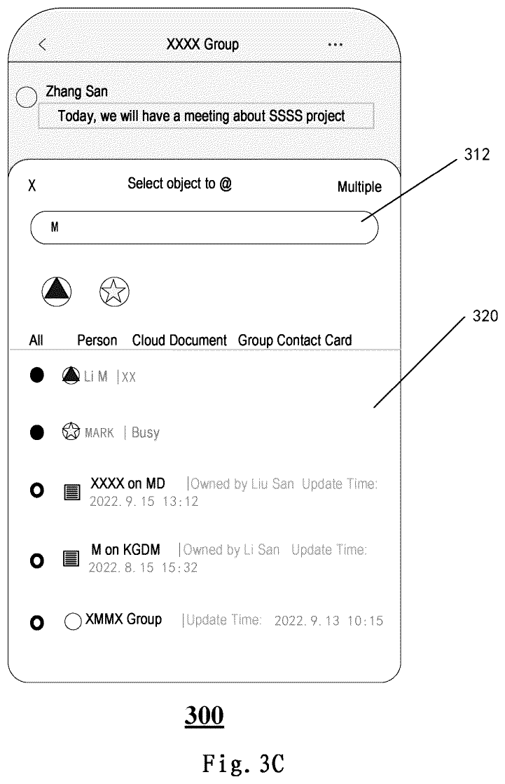

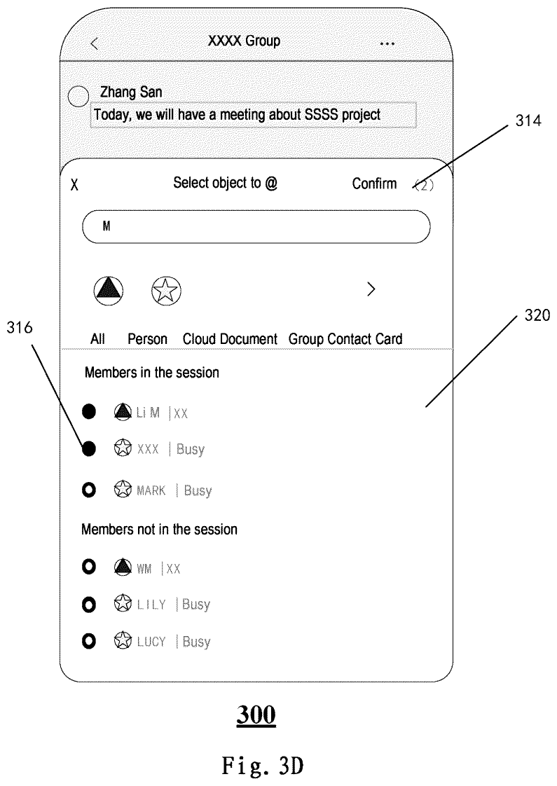

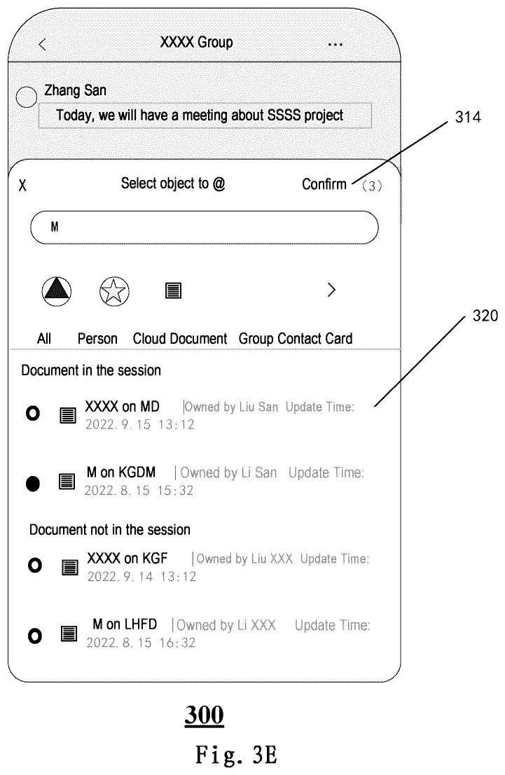

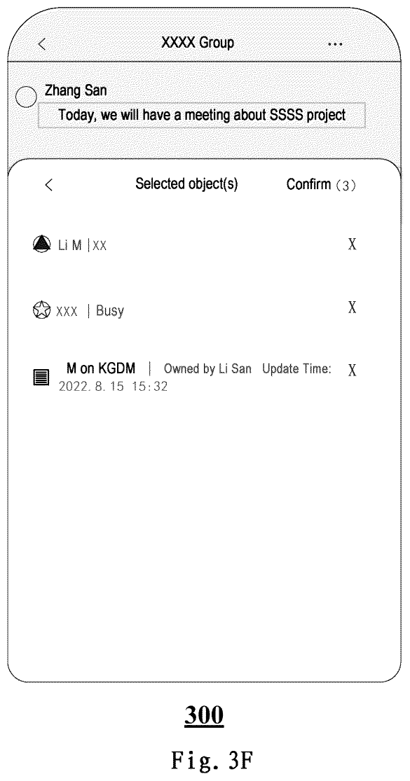

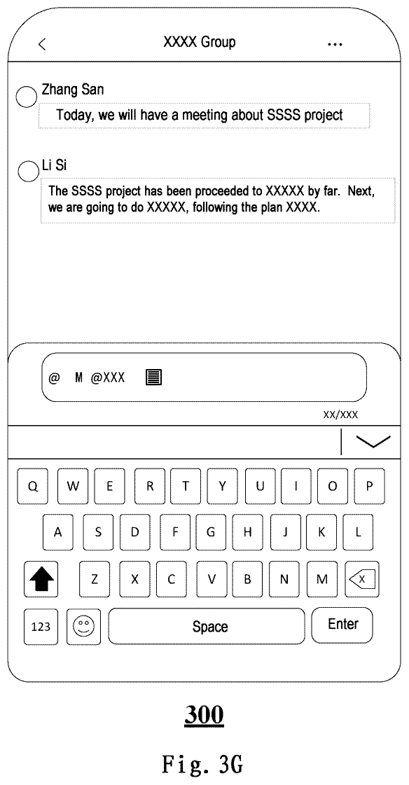

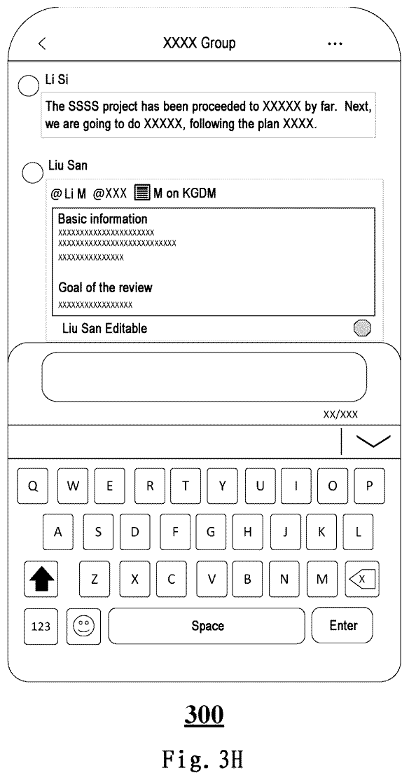

FIG. 3A illustrates a schematic diagram of a further example page 300 according to embodiments of the present disclosure.

As shown in FIGS. 3A-3H, after the first user inputs the preset sign @ in the input field 310 of a service interface 300, a first window 320 may be displayed on the service interface 300, and the first window 320 includes at least one content to be shared. In some embodiments, a category of the at least one content to be shared may include at least one of a personal contact card, a group contact card, and a cloud document. Alternatively, the first window 320 may only partially cover the service interface 300, for example, no more than 80% of the service interface 300.

As shown in FIG. 3A, the first window 320 also includes at least one category label for differentiating categories of contents to be shared, and for displaying contents to be shared in the same category on the same TAB page while displaying contents to be shared in different categories on different TAB pages, such that a user may quickly find a target shared content as desired in the contents to be shared. In some embodiments, the category labels may include a person, a cloud document, a group contact card, an applet and the like, respectively corresponding to category information, such as a personal contact card, a group contact card, a cloud document, an applet and the like. When the first window 320 includes a category label, in response to a trigger operation on a target label in the at least one category label, a content to be shared which matches the target label is displayed in the first window 320.

As shown in FIG. 3B, the first window 320 further includes a search bar 312 therein, and the method may further include: in response to a search operation that is performed based on a keyword in the search bar, displaying a content to be shared that matches the keyword in the first window.

As shown in FIG. 3C, when a search keyword “M” is input in the search bar 312, a content to be shared that matches the keyword “M” are displayed in the first window 320. And specifically, a personal contact card, a group contact card, cloud documents and the like, which match the keyword “M” are displayed in the first window 320.

In some embodiment, as shown in FIGS. 3D and 3E, a second target widget component 314 is set in the first window 320, and the second target widget component 314 is used to implement a multi-selection function. When a first trigger operation on the second target widget component 314 in the first window 320 is detected, a preselection sub-widget component 316 is generated for each of the contents to be shared. In some embodiments, the preselection sub-widget component 316 is used to implement a preselection for a certain content to be shared in the multi-selection function. Then, by means of a selection operation on the preselection sub-widget component 316, at least one target shared content is determined, and identification information of the at least one target shared content is displayed in a target area of the first window 320. For example, identification information, such as an avatar, an icon, and the like, of the at least one content to be shared, is displayed in a target area between the search bar 312 and the at least one content to be shared. Upon clicking an arrow in the area, the page may jump into a page of the selected object(s), in which the first user may view a selected content to be shared and delete a wrongly selected content to be shared, as shown in FIG. 3F. In addition, the second target widget component 314 may display a number of selected contents to be shared.

After the preselection has been completed, upon detecting a second trigger operation on the second target widget component 314, the selected target shared content(s) may be shared to at least one second user account corresponding to the service interface 300. As shown in FIG. 3G, the selected target shared content(s) are displayed in the input field 310, and a widget component for sending is then clicked to cause the contents in the input field 310 to be displayed in the display field, as shown in FIG. 3H.

As described in the above embodiments, in a multi-person interaction scene, the example system 100 according to embodiments of the present disclosure may directly display a first window for displaying contents to be shared, enabling a user to directly select a content desired to be shared in the first window, so as to shorten a content sharing path for a user in the multi-person interaction scene, increase the efficiency of user communication and interaction, and improve user experiences.

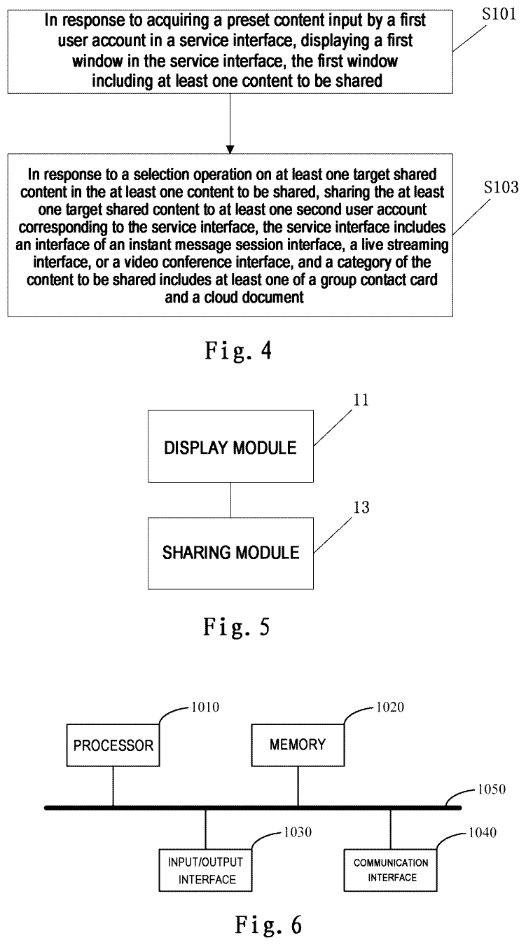

The embodiments of the present disclosure further provide a content sharing method. As shown in FIG. 4, the method may include: step S101, in response to acquiring a preset content input by a first user account in a service interface, displaying a first window in the service interface, the first window including at least one content to be shared; and step S103, in response to a selection operation on at least one target shared content in the at least one content to be shared, sharing the at least one target shared content to at least one second user account corresponding to the service interface, wherein the service interface includes an interface of an instant messaging session interface, a live streaming interface, or a video conference interface; and a category of the at least one content to be shared includes at least one of a group contact card and a cloud document. Alternatively, the category of the at least one content to be shared may further include a personal contact card, an applet and the like, which is not limited in the present disclosure.

In these embodiments, by directly displaying the first window used to display the at least one content to be shared after the preset content is input in the service interface, a user may directly select a desired content to be shared in the first window, thus the content sharing path for the user in a multi-person interaction scene is shortened, the efficiency of user communication and interaction is increase, and user experiences are improved.

In some embodiments, acquiring the preset content input by the first user account in the service interface may include: acquiring a preset sign input by the first user account in an input field of the service interface.

In some embodiments, in response to the selection operation on the at least one target shared content in the at least one content to be shared, sharing the at least one target shared content to at least one second user account corresponding to the service interface in Step S103 may include: step 201, in response to the selection operation on the at least one target shared content in the at least one content to be shared, displaying the at least one target shared content in the input field, such that a preselection for the at least one target shared content in the input field may be implemented; and step 203, in response to a send operation on the input field, displaying the at least one target shared content in a display field of the service interface, such that the second user account may acquire an access to the target shared content(s).

In some embodiments, the at least one target shared content displayed in the input field may include: at least one of a group name corresponding to the group contact card and a document name corresponding to the cloud document.

In some embodiments, displaying the at least one target shared content in the display field of the service interface in Step 203 may include at least one of the following: in response to the at least one target shared content including one of the group name corresponding to the group contact card and the document name corresponding to the cloud document, displaying a card component for the group contact card or a card component for the cloud document respectively corresponding to one of the group contact card and the cloud document, wherein the card component for the group contact card may include an access corresponding to the group contact card, and the card component for the cloud document may include an access corresponding to the cloud document; or in response to the target shared content including both the group name and the document name, displaying, in the display field, the group name, the document name, and respective accesses corresponding to the group name and the document name.

In some embodiments, the at least one target shared content displayed in the input field may include: message information and at least one of a person's name corresponding to the personal contact card, a group name corresponding to the group contact card, and a document name corresponding to the cloud document.

In some embodiments, displaying the at least one target shared content in the display field of the service interface may include at least one of the following: in response to the at least one target shared content including the person's name and the message information, displaying, in the display field, the message information, the person's name, and an access corresponding to the person's name; in response to the at least one target shared content including the message information and one of the group name and the document name, displaying, in the display field, the message information and a card component for the group contact card or card component for the cloud document respectively corresponding to one of the group contact and the cloud document, wherein the card component for the group contact card may include an access corresponding to the group contact card, and the card component for the cloud document may include an access corresponding to the cloud document; or in response to the at least one target shared content including the message information, the group name and the document name, displaying, in the display field, the message information, the group name, the document name and respective accesses corresponding to the group name and the document name.

In some embodiments, displaying the at least one target shared content in the display field of the service interface may further include: setting a first permission of the target shared content to a default value, such that the second user account may perform a first operation on the at least one target shared content.

In some embodiments, displaying the at least one target shared content in the display field of the service interface may further include: in response to a trigger operation on a first target widget component corresponding to the at least one target shared content in the display field, displaying a second window in the service interface; in response to a permission setting operation performed by a user in the second window, setting a second permission of the at least one target shared content to a second permission value, such that the second user account may perform a second operation on the at least one target shared content.

In some embodiments, a number of the second user accounts may be one or more than one, and in response to the second user accounts being more than one, multiple second permissions set for the more than one second user accounts are the same or different.

In some embodiments, the method further includes: acquiring an input content subsequent to the preset content in the input field, and determining, based on the input content subsequent to the preset content, the at least one content to be shared in the first window.

In some embodiments, the first window may include at least one category label, and displaying the first window in the service interface may include: in response to a trigger operation on a target label in the at least one category label, displaying, in the first window, the at least one content to be shared that matches the target label.

In some embodiments, the method further includes: in response to a number of the categories of contents to be shared being at least two, the category label includes: at least two sub-labels each matching a category of the at least one content to be shared; and a second sub-label matching all of the at least one content to be shared.

In some embodiments, the method may further include: displaying, in the first window, label information corresponding to the at least one content to be shared.

In some embodiments, in response to the at least one content to be shared including a personal contact card, the label information may include a personal status and/or a personal label; in response to the at least one content to be shared including a group contact card, the label information includes update time of a group message; in response to the at least one content to be shared being a cloud document, the label information includes a document owner and/or update time of the document.

In some embodiments, a content to be shared being related to the service interface, and/or a content to be shared being not related to the service interface.

In some embodiments, the method may further include displaying a first window in the service interface, the first window including a content to be shared, the method further includes one of the following: displaying, in the first window, only a content to be shared that is related to the service interface; displaying, in the first window, only a content to be shared that is not related to the service interface; or displaying, in the first window, a content to be shared that is related to the service interface, and a content to be shared that is not related to the service interface, respectively.

In some embodiments, the first window further includes a search bar, and the method further includes: in response to a search operation performed based on a keyword in the search bar, displaying, in the first window, the at least one content to be shared that matches the keyword.

In some embodiments, the method further includes: in response to a first trigger operation on a second target widget component in the first window, generating at least one preselection sub-widget component for the at least one contents to be shared, respectively; in response to a selection operation on the at least one preselection sub-widget component, determining the at least one target shared content; in response to a second trigger operation on the second target widget component, sharing the at least one target shared content to a second user account corresponding to the service interface.

In some embodiments, the method further includes: displaying, in the target widget component, a number of the selected at least one target shared contents; and/or displaying, at a target position in the first window, identification information of the selected at least one target shared content.

It is worth noting that the method according to the embodiments of the present disclosure may be executed by a single device, for example, a computer, a server, or the like. The method according to the embodiments of the present disclosure may also be applied to a distributed scene, and implemented cooperatively by multiple devices. In the case of the distributed scene, one of the multiple devices may only execute one or more steps of the method according to embodiments of the present disclosure, and the multiple devices may interact with one another to implement the method as describe above.

It would be appreciated that some embodiments of the present disclosure have been described above. Other embodiments also fall into the scope of the appended claims. In some cases, the actions or steps as recited in the claims may be executed according to a sequence different than the one according to the above embodiments, and the desired result and may still be achieved. In addition, the process depicted in the drawings does not require that the specific sequence or consecutive sequence as shown be followed such that the descried effect can be achieved. In some implementations, multi-task processing and parallel processing may be feasible, or may also be advantageous.

Based on the same invention idea, the present disclosure also provides a content sharing apparatus corresponding to the method according to any of the embodiments as described above.

Referring to FIG. 5, the apparatus includes: a display module 11 configured to: in response to acquiring a preset content input by a first user account in a service interface, display a first window in the service interface, the first window including at least one content to be shared; and a sharing module 13 configured to: in response to a selection operation on at least one target shared content in the at least one content to be shared, share the at least one target shared content to at least one second user account corresponding to the service interface, wherein the service interface include an interface of an instant messaging session interface, a live streaming interface or a video conference interface, and a category of the at least one content to be shared includes at least one of a group contact card and a cloud document.

In some embodiments, the display module 11 is configured to: acquire a preset sign input by the first user account in an input field of the service interface; and the sharing module 13 is configured to: in response to the selection operation on the at least one target shared content in the at least one content to be shared, display the at least one target shared content in the input field; and in response to a send operation on the input field, display the at least one target shared content in a display field of the service interface. In some embodiments, the at least one target shared content displayed in the input field includes: at least one of a group name corresponding to the group contact card and a document name corresponding to the cloud document.

In some embodiments, the display module 11 is configured to implement at least one of the following: in response to the at least one target shared content including one of the group name and the document name, displaying a card component for the group contact card or a card component for the cloud document respectively corresponding to one of the group contact card and the cloud document, wherein the card component for the group contact card includes an access corresponding to the group contact card, and the card component for the cloud document includes an access corresponding to the cloud document; or in response to the at least one target shared content including both the group name and the document name, displaying, in the display field, the group name, the document name and respective accesses corresponding to the group name and the document name.

In some embodiments, the at least one target shared content that is displayed in the input field includes: message information and at least one of a person's name corresponding to the personal contact card, a group name corresponding to the group contact card and a document name corresponding to the cloud document.

In some embodiments, the display module 11 is configured to implement at least one of the following: in response to the at least one target shared content including the person's name and the message information, displaying, in the display field, the message information, the person's name, and an access corresponding to the person's name; in response to the at least one target shared content including the message information and one of the group name and the document name, displaying, in the display field, the message information and a card component for the group contact card or a card component for the cloud document respectively corresponding to one of the group contact card and the cloud document, wherein the card component for the group contact card includes an access corresponding to the group contact card, and the card component for the cloud document includes an access corresponding to the cloud document; or in response to the at least one target shared content including the message information, the group name and the document name, displaying, in the display field, the message information, the group name, the document name and respective accesses corresponding to the group name and the document name.

The display module 11 is configured to: set a first permission of the at least one target shared content to a default value, such that the second user account may perform a first operation on the at least one target shared content.

In some embodiments, the display module 11 is configured to: in response to a trigger operation on a first target widget component corresponding to the at least one target shared content in the display field, display a second window in the service interface; in response to a permission setting operation performed by a user in the second window, set a second permission of the at least one target shared content to a second permission value, such that the second user account may perform a second operation on the at least one target shared content.

In some embodiments, a number of the second user accounts may be one or more than one, and in response to the second user accounts being more than one, multiple second permissions set for the more than one second user accounts are the same or different.

In some embodiments, the apparatus is further configured to: acquire an input content subsequent to the preset content in the input field; and determine, based on the input content subsequent to the preset content, the at least one content to be shared in the first window.

In some embodiments, the first window includes at least one category label, the display module 11 is configured to: in response to a trigger operation on a target label in the at least one category label, display, in the first window, the at least one content to be shared that matches the target label.

In some embodiments, the apparatus is further configured to: in response to a number of categories of the at least one content to be shared being at least two, the category label includes: at least two sub-labels, each matching a category of the at least one content to be shared; and a second sub-label matching all of the at least one content to be shared.

In some embodiments, the apparatus is further configured to: display, in the first window, label information corresponding to the at least one content to be shared.

In some embodiments, the apparatus is further configured such that: in response to the at least one content to be shared including a personal contact card, the label information includes a personal status and/or a personal label; in response to the at least one content to be shared including a group contact card, the label information includes update time of a group message; in response to the at least one content to be shared including a cloud document, the label information includes a document owner and/or a update time of the document.

In some embodiments, a content to be shared is related to the service interface, and/or a content to be shared is not related to the service interface.

In some embodiments, the display module 11 is configured to implement one of the following: displaying, in the first window, only a content to be shared that is related to the service interface; displaying, in the first window, only a content to be shared that is not related to the service interface; or displaying, in the first window, a content to be shared that is related to the service interface and a content to be shared that is not related to the service interface, respectively.

In some embodiments, the first window further includes a search bar, and the apparatus is further configured to: in response to a search operation performed based on a keyword in the search bar, display, in the first window, the at least one content to be shared that matches the keyword.

In some embodiments, the apparatus is further configured to: in response to a first trigger operation on a second target control in the first window, generate at least one preselection sub-widget component for the at least one content to be shared, respectively; in response to a selection operation on the preselection sub-widget component, determine the at least one target shared content; or in response to a second trigger operation on the second target control, share the at least one target shared content to a second user account corresponding to the service interface.

In some embodiments, the apparatus is further configured to: display, in the target control, a number of the at least one selected target shared content; and/or display, at a target position in the first window, identification information of the selected at least one target shared content.

For ease of description, the description has been made respectively on the respective modules of the apparatus divided according to functions. When the present disclosure is carried out, the functions of the respective modules may be implemented in one or more software and/or hardware components.

The apparatus according to any one of the above embodiments is used to implement the respective service arrangement method according to any one of embodiments as descried above, and has advantageous effects of the corresponding method embodiments, which are omitted here for brevity.

Based on the same invention idea, the present disclosure further provides an electronic device corresponding to the method according to any one of the embodiments as described above, including a memory, a processor and a computer program stored on the memory and configured to be executed on the processor. The processor, when executing the program, implements the method of any one of the embodiments as described above.

FIG. 6 illustrates a schematic diagram of a specific electronic device hardware structure provided according to embodiments of the present disclosure. The device may include: a processor 1010, a memory 1020, an input/output interface 1030, a communication interface 1040, and a bus 1050. In some embodiments, the processor 1010, the memory 1020, the input/output interface 1030, and the communication interface are communicatively connected within the device via the bus 1050.

The processor 1010 may be implemented using a general-purpose Central Processing Unit (CPU), a microprocessor, an Application Specific Integrated Circuit (ASIC) or one or more integrated circuits, and configured to execute related programs, to carry out the technical solution provided by the embodiments of the present disclosure.

The memory 1020 may be implemented in the form of a Read Only Memory (ROM), a Random Access Memory (RAM), a static storage device, a dynamic storage device or the like. The memory 1020 may store an operating system and other application programs, and when the technical solution provided by embodiments of the present disclosure is implemented by software or firmware, the related program code is stored in the memory 1020, and called and executed by the processor 1010.

The input/output interface 1030 is used to connect with an input/output module, to implement information input/output. The input/output module may act as a component configured in the device (not shown), or may be connected externally to the device to provide respective functions. The input device may include a keyboard, a mouse, a touch screen, a microphone, various types of sensors or the like, and the output device may include a display, a loudspeaker, a vibrator, an indicator light or the like.

The communication interface 1040 is used to connect with a communication module (not shown), to implement communication interaction between the device and other devices. The communication module may implement communication in a wired manner (e.g. a universal serial bus (USB), a cable and the like), or may implement communication in a wireless manner (e.g. a mobile network, WIFI, Bluetooth or the like).

The bus 1050 includes a path for transmitting information among the respective components (e.g., the processor 1010, the memory 1020, the input/output interface 1030, and the communication interface 1040) of the device.

It is worth noting that, although only the processor 1010, the memory 1020, the input/output interface 1030, the communication interface 1040 and the bus 1050 are shown in the device, the device may include other components necessary for normal operation in the specific implementation. In addition, it would be appreciated by those skilled in the art that the above device may include components necessary for carrying out the solution according to the embodiments of the present disclosure, rather than covering all the components shown in the drawings.

The electronic device according to the above embodiments is used to implement the respective methods according to any one of the embodiments as described previously, and can achieve the advantageous effects according to the corresponding method embodiments, which are omitted herein for brevity.

Based on the same invention ideas, the present disclosure also provides a non-transient computer readable storage medium storing computer instructions, where the computer instructions are used to cause a computer to implement a method according to any one of the embodiments as described previously.

The computer readable medium according to embodiments of the present disclosure may be permanent or non-permanent, removable or non-removable medium that may implement information storage using any method or technology. The information may be a computer readable instruction, a data structure, a module of a program or other data. Examples of the storage medium of the computer include, but are not limited to, a Phase Change Random Access Memory (PRAM), a dynamic Random Access Memory (DRAM), other type of Random Access Memory (RAM), Read Only Memory (ROM), Electrically Erasable Programmable Read Only Memory (EEPROM), a flash memory or other memory technology, a Compact Disc Read-Only Memory (CD-ROM), a Digital Versatile Disc (DVD) or other optical memory, a magnetic cassette, a tape magnetic storage device or other magnetic storage device, and any other non-transmission medium, which may be used to store information that may be accessed by a computing device.

The computer instructions stored in the storage medium according to the above embodiments are used to cause the computer to perform a method according to any one of embodiments as described above, and have the advantageous effects of the corresponding method embodiments, which is omitted herein for brevity.

Based on the same invention conception, the present disclosure further provides a computer program product comprising a computer program, corresponding to a method according to any one of the embodiments of the present disclosure. In some embodiments, the computer program is executable by one or more processors to cause the processors to execute a method according to the above embodiments of the present disclosure.

The computer program product according to the above embodiments is used to cause processors to execute a method according to any one of the above embodiments, and has the advantageous effects of the corresponding method embodiments, which is omitted herein for brevity.

It would be appreciated by those skilled in the art that the discussion on any one of embodiments as described above is provided for examples, without implying that the scope of the present disclosure (including claims) are confined to those examples. According to the conception of the present disclosure, the technical features in the above embodiments or different embodiments may also be combined, the steps may be implemented in any sequence, and there are a lot of other variations of different aspects of the embodiments of the present disclosure as described above, which are not described in detail for brevity.

In addition, in order to simplify illustration and discussion and to make the embodiments of the present disclosure apparent, known power/ground connections to Integrated Circuit (IC) chips and other components may be shown, or may not be shown, in the accompanying drawings. Further, the apparatus may be shown in a form of a block diagram to make the embodiments of the present disclosure apparent, and the following factor is also taken into consideration, i.e., details about the implementation of the apparatus in the block diagram is highly dependent on the platform where the embodiments of the present disclosure are to be implemented (i.e., those details should be fully understandable to those skilled in the art). In the case where details (e.g. circuits) are illustrated to describe example embodiments of the present disclosure, it is obvious to those skilled in the art that the embodiments of the present disclosure could be implemented if those details are missing, or changed. Therefore, the description should be construed as being illustrative, rather than restrictive.

Although description has been made previously on the present disclosure with reference to the specific embodiments thereof, lots of substitutions, modifications and variations of those embodiments are obvious to the ordinary skilled in the art according to the previous description. For example, embodiments discussed herein may be employed in another memory architecture (e.g. dynamic RAM (DRAM)).

Embodiments of the present disclosure intend to cover all the substitutions, modifications and variations falling within the broad scope of the claims appended thereafter. Therefore, any omission, modification, equivalent substitution, improvement and the like made within the spirits and principle of the embodiments of the present disclosure shall all fall into the protection scope of the present disclosure.

I/We claim:

1. A method of content sharing, comprising:
in response to acquiring a preset content input by a first user account in a service interface, displaying a first window in the service interface, the first window comprising at least one content to be shared; and
in response to a selection operation on at least one target shared content in the at least one content to be shared, sharing the at least one target shared content to at least one second user account corresponding to the service interface;
wherein the service interface comprises one of an instant messaging session interface, a live streaming interface, or a video conference interface, and a category of the at least one content to be shared comprises at least one of a group contact card and a cloud document.

2. The method of claim 1, wherein acquiring the preset content input by the first user account in the service interface comprises: acquiring a preset sign input by the first user account in an input field of the service interface; and
wherein in response to the selection operation on the at least one target shared content in the at least one content to be shared, sharing the at least one target shared content to the at least one second user account corresponding to the service interface comprises:
in response to the selection operation on the at least one target shared content in the at least one content to be shared, displaying the at least one target shared content in the input field; and
in response to a send operation on the input field, displaying the at least one target shared content in a display field of the service interface.

3. The method of claim 2, wherein the at least one target shared content displayed in the input field comprises at least one of a group name corresponding to the group contact card and a document name corresponding to the cloud document; and
wherein displaying the at least one target shared content in the display field of the service interface comprises at least one of:
in response to the at least one target shared content comprising one of the group name and the document name, displaying a card component for the group contact card or a card component for the cloud document respectively corresponding to one of the group contact card and the cloud document in the display field, wherein the card component for the group contact card comprises an access corresponding to the group contact card, and the card component for the cloud document comprises an access corresponding to the cloud document; or
in response to the at least one target shared content comprising both the group name and the document name, displaying the group name, the document name, and respective accesses corresponding to the group name and the document name in the display field.

4. The method of claim 2, wherein the at least one target shared content displayed in the input field comprises: message information and at least one of a person's name corresponding to a personal contact card, a group name corresponding to the group contact card and a document name corresponding to the cloud document; and
wherein displaying the at least one target shared content in the display field of the service interface comprises at least one of:
in response to the at least one target shared content comprising the message information and the person's name, displaying the message information, the person's name, and an access corresponding to the person's name in the display field;
in response to the at least one target shared content comprising the message information and one of the group name and the document name, displaying, in the display field, the message information and a card component for the group contact card or a card component for the cloud document respectively corresponding to one of the group contact card and the cloud document, wherein the card component for the group contact card comprises an access corresponding to the group contact card, and the card component for the cloud document comprises an access corresponding to the cloud document; or
in response to the at least one target shared content comprising the message information, the group name and the document name, displaying, in the display field, the message information, the group name, the document name, and respective accesses corresponding to the group name and the document name.

5. The method of claim 2, wherein displaying the at least one target shared content in the display field of the service interface further comprises:
setting a first permission of the at least one target shared content to a default value, such that the at least one second user account performs a first operation on the at least one target shared content.

6. The method of claim 2, where displaying the at least one target shared content in the display field of the service interface further comprises:
in response to a trigger operation on a first target widget component corresponding to the at least one target shared content in the display field, displaying a second window in the service interface; and
in response to a permission setting operation performed by a user in the second window, setting a second permission of the at least one target shared content to a second permission value, such that the at least one second user account performs a second operation on the at least one target shared content, and
wherein a number of the at least one second user account may be one or more, and in response to the at least one second user account comprises a plurality of accounts, a plurality of second permissions set for the plurality of second user accounts are the same or different.

7. The method of claim 2, further comprising:
acquiring an input content subsequent to the preset content in the input field; and
determining, based on the input content subsequent to the preset content, the at least one content to be shared in the first window.

8. The method of claim 1, wherein the first window comprises at least one category label, and wherein displaying the first window in the service interface comprises:
in response to a trigger operation on a target label in the at least one category label, displaying, in the first window, the at least one content to be shared that matches the target label.

9. The method of claim 8, further comprising:
in response to a number of categories of the at least one content to be shared being at least two, the category label comprises:
at least two first sub-labels, each of at least two first sub-labels matching a category of the content to be shared; and
a second sub-label matching all of the at least one content to be shared.

10. The method of claim 1, further comprising:
displaying, in the first window, label information corresponding to the at least one content to be shared.

11. The method of claim 10, wherein:
in response to the at least one content to be shared including a personal contact card, the label information comprises a personal status and/or a personal label;
in response to the at least one content to be shared including a group contact card, the label information comprises update time of a group message; or
in response to the at least one content to be shared including a cloud document, the label information comprises a document owner and/or update time of the document.

12. The method of claim 1, wherein a content to be shared is related to the service interface, and/or a content to be shared is not related to the service interface; and
wherein displaying a first window in the service interface, the first window comprising at least one content to be shared, further comprising one of:
displaying, in the first window, only the content to be shared that is related to the service interface;
displaying, in the first window, only the content to be shared that is not related to the service interface; or
displaying, in the first window, the content to be shared that is related to the service interface, and the content to be shared that is not related to the service interface, respectively.

13. The method of claim 1, wherein the first window further comprises a search bar and wherein the method further comprises:
in response to a search operation performed based on a keyword in the search bar, displaying the at least one content to be shared that matches the keyword in the first window.

14. The method of claim 1, further comprising:
in response to a first trigger operation on a second target widget component in the first window, generating a preselection sub-widget component for each of the at least one content to be shared;
in response to a selection operation on the preselection sub-widget component, determining at least one target shared content; and
in response to a second trigger operation on the second target widget component, sharing the at least one target shared content to the at least one second user account corresponding to the service interface.

15. The method of claim 14, further comprising:
displaying, in the target widget component, a number of the at least one selected target shared content; and/or
displaying, at a target position in the first window, identification information of the at least one selected target shared content.

16. An electronic device, comprising:
a processor;
a memory, coupled to the processor, wherein a program is stored on the memory and configured to be executable on the processor, wherein when the program is executed by the processor, the electronic device is caused to:
in response to acquiring a preset content input by a first user account in a service interface, displaying a first window in the service interface, the first window comprising at least one content to be shared; and
in response to a selection operation on at least one target shared content in the at least one content to be shared, sharing the at least one target shared content to at least one second user account corresponding to the service interface;
wherein the service interface comprises one of an instant messaging session interface, a live streaming interface, or a video conference interface, and a category of the at least one content to be shared comprises at least one of a group contact card and a cloud document.

17. The electronic device of claim 16, wherein the electronic device is caused to acquire the preset content input by the first user account in the service interface by acquiring a preset sign input by the first user account in an input field of the service interface; and
wherein in response to the selection operation on the at least one target shared content in the at least one content to be shared, the electronic device is caused to share the at least one target shared content to the at least one second user account corresponding to the service interface by:
in response to the selection operation on the at least one target shared content in the at least one content to be shared, displaying the at least one target shared content in the input field; and
in response to a send operation on the input field, displaying the at least one target shared content in a display field of the service interface

18. The electronic device of claim 16, wherein the electronic device is further caused to:
in response to a first trigger operation on a second target widget component in the first window, generating a preselection sub-widget component for each of the at least one content to be shared;
in response to a selection operation on the preselection sub-widget component, determining at least one target shared content; and
in response to a second trigger operation on the second target widget component, sharing the at least one target shared content to the at least one second user account corresponding to the service interface.

19. The electronic device of claim 18, wherein the electronic device is further caused to:
displaying, in the target widget component, a number of the at least one selected target shared content; and/or
displaying, at a target position in the first window, identification information of the at least one selected target shared content.

20. A non-transient computer readable storage medium having program instructions stored thereon which, when executed by a processor, cause the processor to perform actions, comprising:
in response to acquiring a preset content input by a first user account in a service interface, displaying a first window in the service interface, the first window comprising at least one content to be shared; and
in response to a selection operation on at least one target shared content in the at least one content to be shared, sharing the at least one target shared content to at least one second user account corresponding to the service interface;
wherein the service interface comprises one of an instant messaging session interface, a live streaming interface, or a video conference interface, and a category of the at least one content to be shared comprises at least one of a group contact card and a cloud document.
